(19) United States
(12) Patent Application Publication
(10) Pub. No.: US 2018/0101916 A1
(43) Pub. Date: Apr. 12, 2018

(54) METHODS AND SYSTEMS FOR SCHEDULING APPOINTMENT THROUGH HOST SERVER AND MONITORING THE APPOINTMENT IN A DYNAMIC VIRTUAL ENVIRONMENT

(71) Applicant: Anthony Bellassai, Glendale, AZ (US)

(72) Inventor: Anthony Bellassai, Glendale, AZ (US)

(73) Assignee: Pinpointappointment.com, LLC, Glendale, AZ (US)

(21) Appl. No.: 15/287,024

(22) Filed: Oct. 6, 2016

(51) Int. Cl. G06Q 50/16; G06Q 10/10; G06Q 50/26

(52) U.S. Cl. CPC G06Q 50/16; G06Q 50/265; G06Q 10/1095

(57) ABSTRACT

A method and a system is for scheduling an appointment between a user and diet through a host server and further transmitting the appointment information to a network ready device for monitoring the appointment. The method includes registering by receiving name, email, password, phone number of the real user and client. Then the method includes storing the received information. Further, the method includes verifying the stored information by sending a confirmation code to a computing device. The method then includes scheduling the appointment of client with user, and sending the scheduled appointment to the client to get confirmation. The scheduled information includes a date, a time and a location of a place to meet. The method includes displaying calendar of the scheduled appointments. Then the method includes tracking the movement of the client in real time.

### TECHNICAL FIELD

The presently disclosed embodiments are related, in general, to scheduling and making an appointment between a real estate agent and a user/client. More particularly, the presently disclosed embodiments are related to methods and systems for scheduling an appointment between a real estate agent and a user through a host server and further transmitting the appointment information via a communication network to a network ready device for monitoring the appointment in a dynamic virtual environment.

### BACKGROUND

With more empty homes and violence is causing real estate agents to fall victim to violent crime and sometimes their life. Violence in the real estate business has been increasing dramatically in the past decade. Further, there is a constant threat when a real estate agent/user or homeowner agrees to meet with a stranger prospect while visiting a house for sale or rent. The potential for conflict has sometimes led to well-publicized incidents of theft, violence or worse. Generally, the problem stems from the fact that the realtor simply does not know the person he is meeting with, or who is on the other end of the phone. Even sitting at the house for rent or sell puts the realtor in a vulnerable position.

The existing system and methods often rely on the realtors to update their location. Further, these systems do not provide real-time tracking of the prospect, and lack the cross verification of the schedule appointment of the realtor and the prospects. Hence, there is a need for a method and a system for scheduling the appointment between a real estate agent and a user/client through a host server and further transmitting the appointment information via a communication network to a network ready device for monitoring the appointment in a dynamic virtual environment.

Further limitations and disadvantages of conventional and traditional methods and systems will become apparent to one of skill in the art, through comparison of described methods and compositions with some aspects of the present disclosure, as set forth in the remainder of the present application and with reference to the drawings and Tables.

### SUMMARY

A method and a system for scheduling an appointment between a real estate agent and a user through a host server are provided substantially as shown in, and/or described in connection with, at least one of the figures, as set forth more completely in the claims.

According to embodiments illustrated herein, there is provided a method for scheduling an appointment between a real estate agent and a user through a host server and further transmitting the appointment information via a communication network to a network ready device for monitoring the appointment in a dynamic virtual environment. The method includes registering by receiving name, email, password, phone number, and image pertaining to the real agent and the user.

The method further includes storing the received information. Then the method includes verifying the stored information by sending a text message to the smartphone/computing device. Further, the method includes scheduling the appointment of the user with the real estate agent, and includes sending the scheduled appointment by the real estate agent to the user to get confirmation from the user. The scheduled information includes a date, a time and a location of a place to meet. Further, the method includes displaying a calendar of the scheduled appointments in the smartphone/computing unit corresponding with the real estate agent and the user. Thereafter the method also includes tracking the movement of the user in order to guide the user to reach at the scheduled location.

According to embodiments illustrated herein, there is provided a system that comprises of an application server to schedule an appointment between a real estate agent and a user through a host server and further transmits the appointment information via a communication network to a network ready device to monitor and track the appointment in a dynamic virtual environment.

The application server further comprises of one or more processors configured to register by receiving name, email, password, phone number and image pertaining of the user. One or more processors are further configured to store the received information. Then the one or more processors configured to verify the stored information by sending a confirmation code to a computing device. Thereafter the one or more processors configured to schedule the appointment of the client with the real estate agent are confirmed in an embodiment, and the scheduled information includes a date, a time and a location of a place to meet.

The one or more processors further configured to display a calendar of the scheduled appointments in the computing unit corresponding to the real estate agent/user and the Client. The one or more processors then configured to track the movement of the client and further guide them to reach at the scheduled location.

According to embodiments illustrated herein, a non-transitory computer-readable storage medium having stored thereon, a set of computer-executable instructions for causing a computer comprising one or more processors to perform steps of registering by receiving name, email, password, phone number and image pertaining to the real agent and the client

The one or more processors are further configured to store the received information. Then the one or more processors configured to verify the stored information by sending a confirmation code to a computing device. Thereafter the one or more processors configured to schedule the appointment of the user with the real estate agent. The one or more processors further configured to send the scheduled appointment by the user to the client to get confirmation from the client. In an embodiment, the scheduled information includes a date, a time and a location of a place to meet. The one or more processors further configured to display a calendar of the scheduled appointments in the computing unit corresponding to the user and the client. The one or more processors then configured to track the movement of the client by the user in order to keep track of the client and also give directions to the client reach at the scheduled location.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates an application server configured to schedule an appointment between a user and a client through a host server and further transmits the appointment information via a communication network to a network ready device to monitor the appointment in a dynamic virtual environment, in accordance with at least one embodiment;

FIG. 2 illustrates a flowchart of a method scheduling an appointment between a user and a client through a host server and further transmitting the appointment information via a communication network to a network ready device for monitoring the appointment in a dynamic virtual environment, in accordance with at least one embodiment;

FIG. 3 is a screenshot depicting the signup screen for a user, friend or a client, in accordance with at least one embodiment;

FIG. 4 is a screenshot depicting the login screen for a user, friend or a client, in accordance with at least one embodiment;

FIG. 5 is a screenshot depicting the make an appointment screen for a user, in accordance with at least one embodiment;

FIG. 6 is a screenshot depicting the appointment list screen for a user, in accordance with at least one embodiment;

FIG. 7 is a screenshot depicting the appointment calendar screen for a user, in accordance with at least one embodiment;

FIG. 8 is a screenshot depicting the screen of panic button and details of the friend of a user, in accordance with at least one embodiment;

FIG. 9 is a screenshot depicting the add friend screen, in accordance with at least one embodiment;

FIG. 10 is a screenshot depicting the settings screen, in accordance with at least one embodiment;

FIG. 11 is a screenshot depicting the edit profile screen, in accordance with at least one embodiment;

FIG. 12 is a screenshot depicting the route-tracking screen, in accordance with at least one embodiment; and

FIG. 13 is a screenshot depicting the welcome screen, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

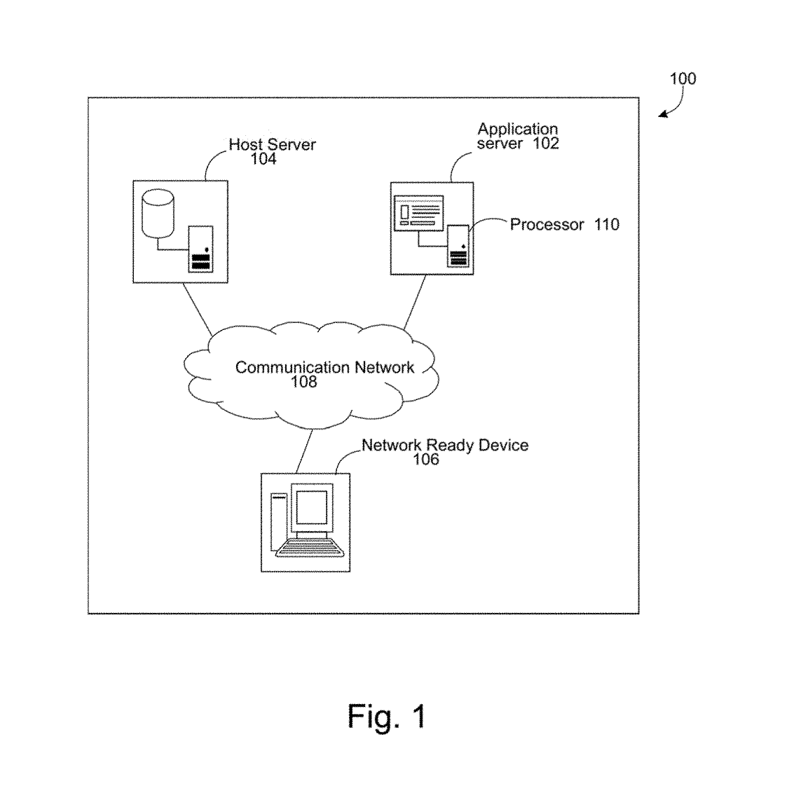

FIG. 1 illustrates block diagram that illustrates an application server 102 configured to schedule an appointment in between a user and a client through a host server 104 and further transmits the appointment information via a communication network 108 to a network ready device 106 to monitor the appointment in a dynamic virtual environment, in accordance with at least one embodiment.

In an embodiment, the communication network 108 includes a medium through which a content communications host server 104, one or more network ready devices 106, and the application server 102 communicate with each other. Such a communication is performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 108 includes, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

In an embodiment, the application server 102 includes a processor 110. The processor 110 is implemented based on a number of processor technologies known in the art. Examples of the processor 110 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

In an embodiment, the application server 102 refers to a computing device or a software framework hosting an application or a software service. In an embodiment, the application server 102 is implemented to execute procedures such as, but not limited to, programs, routines, or scripts stored in one or more memories for supporting the hosted application or the software service. In an embodiment, the hosted application or the software service is configured to perform one or more predetermined operations. The application server 102 is realized through various types of application servers such as, but not limited to, a Java application server, a .NET framework application server, a Based application server, a PHP framework application server, or any other application server framework.

The one or more processors 110 are configured to register by receiving name, email, password, phone number, and image pertaining to the real agent and the user. The one or more processors 110 are further configured to store the received information. Then the one or more processors 110 configured to verify the stored information by sending a confirmation code to a computing device. Thereafter the one or more processors 110 configured to schedule the appointment of the user with the real estate agent.

The one or more processors 110 further configured to send the scheduled appointment by the real estate agent to the user to get confirmation from the user. In an embodiment, the scheduled information includes a date, a time and a location of a place to meet. Therefore the appointment scheduled in both the calendars of the user and the client. This maintains a record of correspondence and of the meeting. The record may become important in the event of an investigation. Notably, the calendar may be a custom application. In the invention's preferred embodiment, this is a custom Calendar implemented using Objective C for iPhone, iPad, or tablet. Alternative or future embodiments of the invention may utilize a different calendar application. The calendar may be a type which is integrated into smartphones.

The one or more processors 110 further configured to display a calendar of the scheduled appointments in the computing unit corresponding to the real estate agent and the user. The one or more processors 110 then configured to track the movement of the user to the scheduled location. The one or more processors 110 further configured to add friend to track the user in real time over a digital map. The one or more processors 110 further configured to initiate an alarm in case of an emergency by the user.

For example, the user sends an appointment with address confirmation to the client. When the client accepts the appointment, the appointment shows up in both users' calendars; at the same time, this automatically makes the client accept the user agreement by doing so. This allows the present system to track the movements in real time of the client to the address where they are both meeting, and records the address in the backend website.

Further, the present system 100 cross-verifies whom the user sets the appointment with, and the time of the appointment with third-party sources such as social media accounts, includes but not limited to Facebook, twitter, etc. In the preferred embodiment, this operation may executed by a social media API, web crawling, or similar means. Furthermore, prior to the user or client's appointment, a reminder issued to the client. The process tracks the client, and offers to guide the client in to the location via a GPS map routing sub-process with displayed map. At the same time, the system 100 notifies the user when the client is in route, and the user may follow the client as they travel to the appointment's location.

The present system 100 also allows the user to designate permissions for other third parties, such as friends, family or a boss, to track them in real time as well. In the invention's preferred embodiment, the number of friends is two. This third-party tracking feature is designed to add an additional measure of safety to the friend and the user.

In an embodiment, the content communications host server 104 is operable to execute one or more semantic queries to enable implementation of machine-learning techniques. The content communications host server 104 is realized through various technologies such as, but not limited to, Microsoft SQL Server, Oracle®, IBM DB2®, Microsoft Access®, PostgreSQL®, MySQL® and SQLite®, and the like.

Examples of the network ready device 106 include, but are not limited to, a personal computer, a laptop, a personal digital assistant (PDA), a mobile device, a tablet, or iPad.

A person skilled in the art will understand that the scope of the disclosure should not be limited to schedule an appointment between a real estate agent and a user through a host server 104 and further transmits the appointment information via a communication network 108 to a network ready device 106 to monitor the appointment in a dynamic virtual environment.

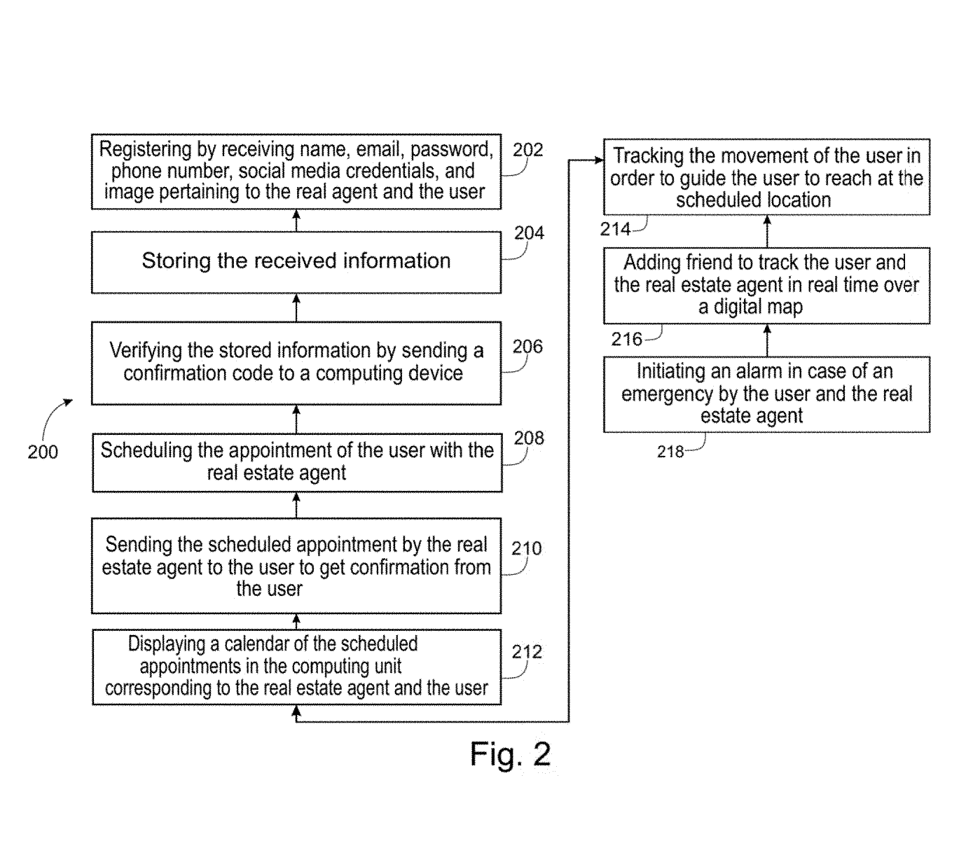

FIG. 2 illustrates a flowchart 200 of a method for scheduling an appointment between a real estate agent and a user through a host server and further transmitting the appointment information via a communication network to a network ready device for monitoring the appointment in a dynamic virtual environment, in accordance with at least one embodiment. The flowchart 200 is described in conjunction with FIG. 1.

The method starts at step 202 of registering by receiving name, email, password, phone number pertaining to the client and the user. The method further includes the step 204 of storing the received information. Then the method includes the step 206 of verifying the stored information by sending a confirmation code to a computing device. Further, the method includes the step 208 of scheduling the appointment of the user with the real estate agent. Then the method includes the step 210 of sending the scheduled appointment by the user to get confirmation from the client. The scheduled information includes a date, a time and a location of a place to meet. Further, the method includes the step 212 of displaying a calendar of the scheduled appointments in the computing unit corresponding to the real estate agent and the user. Thereafter the method includes the step 214 of tracking the movement of the client in order to help guide them to meet at the scheduled location.

The method further includes the step 216 of adding friend to track the user in real time over a digital map. Then the method includes the step 218 of initiating an alarm in case of an emergency by the user.

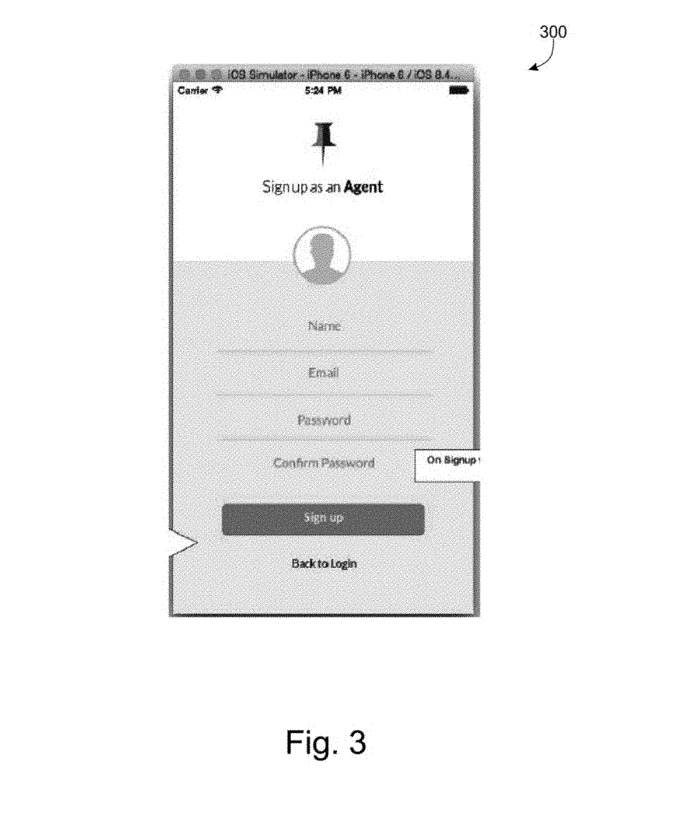

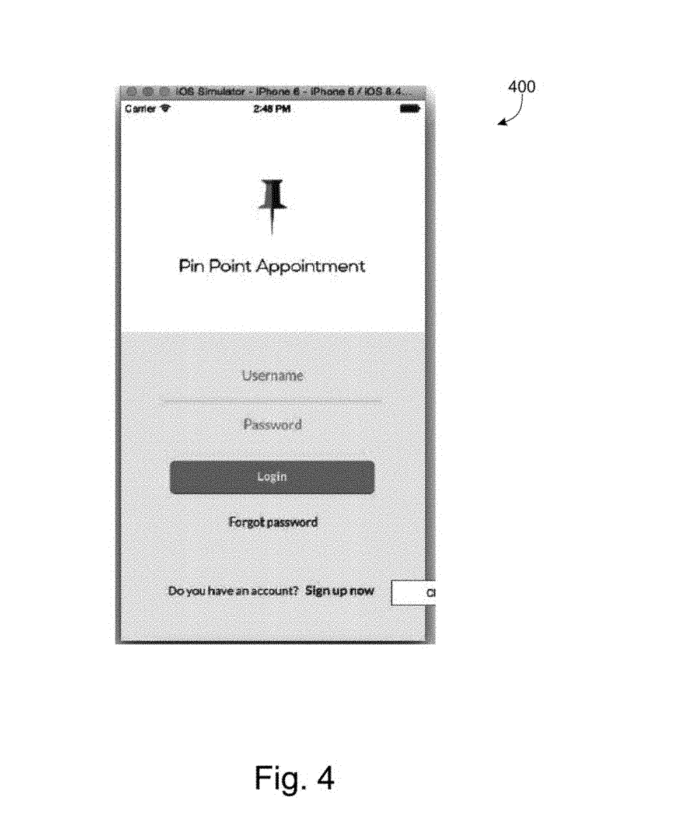

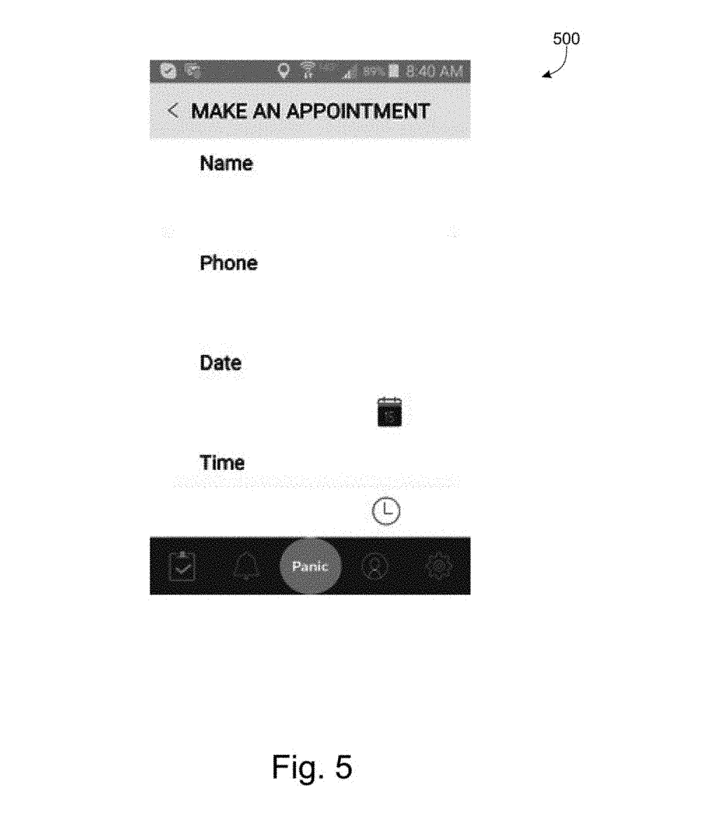

FIG. 3 is a screenshot depicting the signup screen 300 for a user and a client, in accordance with at least one embodiment. FIG. 4 is a screenshot depicting the login screen 400 for a user, friend and a client, in accordance with at least one embodiment. FIG. 5 is a screenshot depicting the make an appointment screen 500 for a user, in accordance with at least one embodiment. In order to make an appointment the user has to provide his/her name, phone number, desired date, and time to meet with the users and check out the property. The screen 500 also shows a panic module to enable the user to notify his/her friends or relative in case of emergency or any accident.

The registry process has a number of benefits such as the user may stay safer in a vacant or open house by verifying the integrity of the information the client gives quickly. The user may be able to gain legitimate information. The user may instantly verify the phone number of the user or client while they are standing in front of the user. The user may have that information sent directly to his/her list offsite for an added level of security. The present system and method enables the user to stay safer and gain more legitimate contact information.

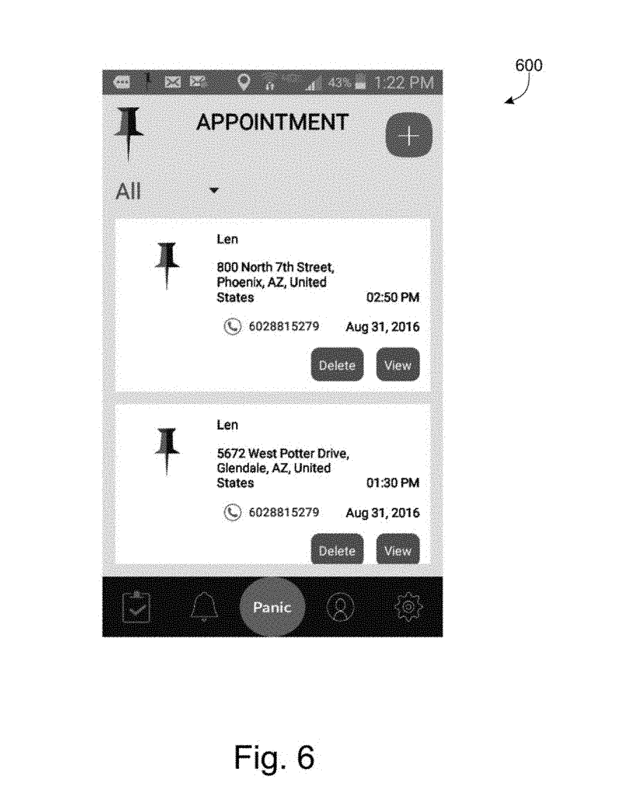

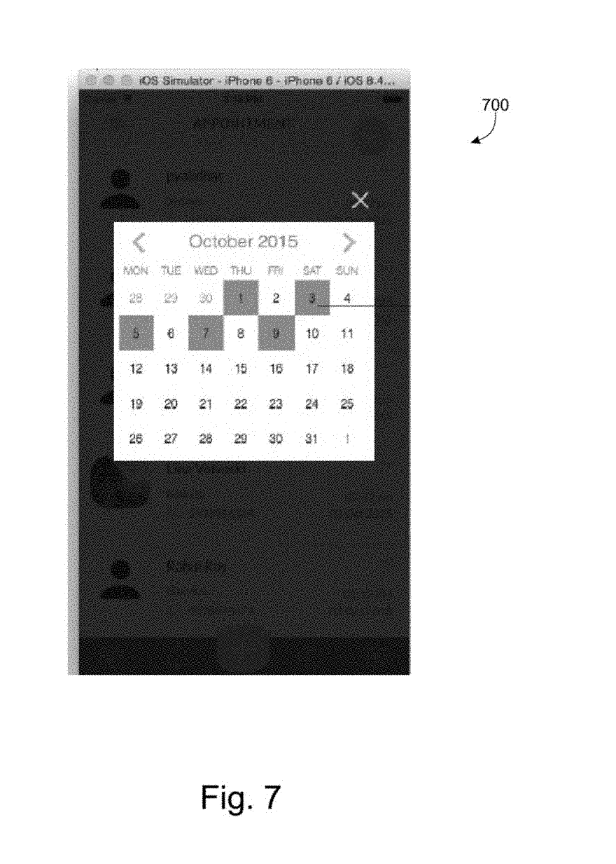

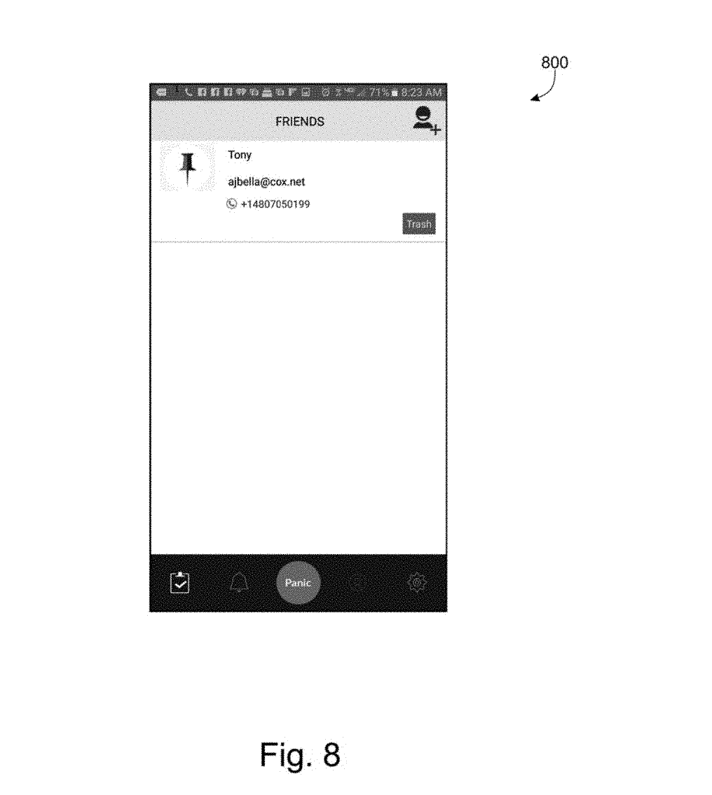

FIG. 6 is a screenshot depicting the appointment list screen 600 for a user, in accordance with at least one embodiment. FIG. 7 is a screenshot depicting the appointment calendar screen 700 for the user, in accordance with at least one embodiment. FIG. 8 is a screenshot depicting the screen 800 of panic button and details of the friend of a user, in accordance with at least one embodiment. If the panic button is pressed, the system may immediately start the call police sequence and pinpoint the user's location, alert friends selected, send them a map of the user's location via text, and push notification.

Alternative or future embodiments of the invention may in the future support a variety of different alarm types and light patterns. Users may also be able to upload and/or create their own alarm types and light patterns later as the product evolves.

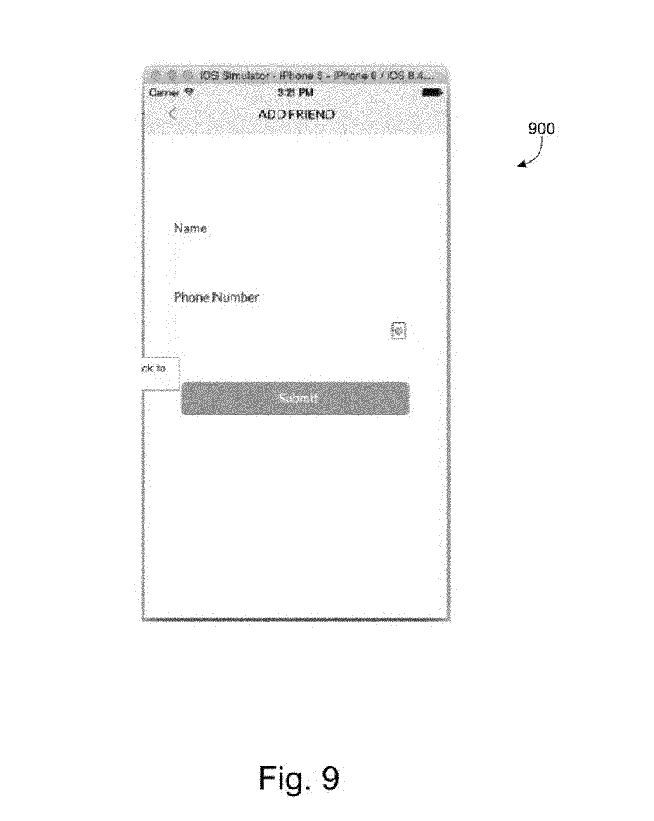

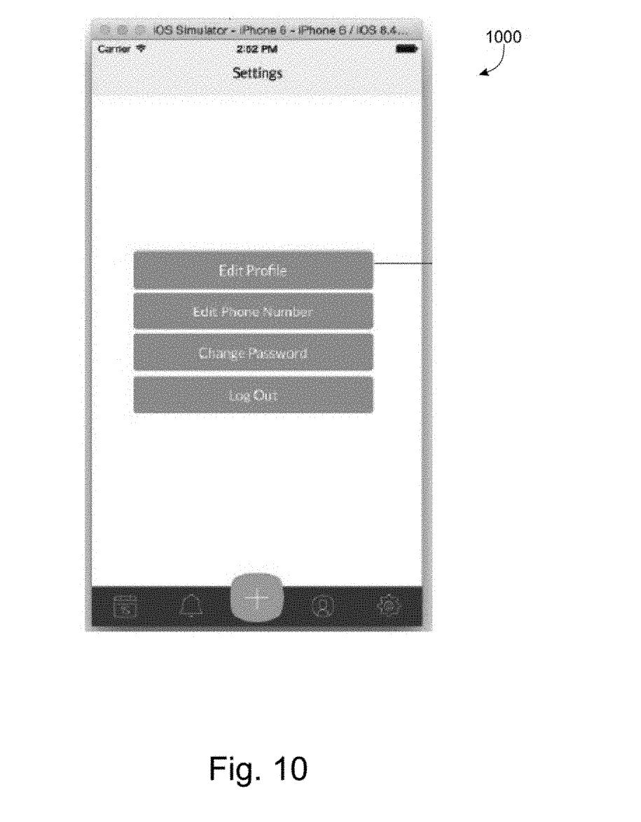

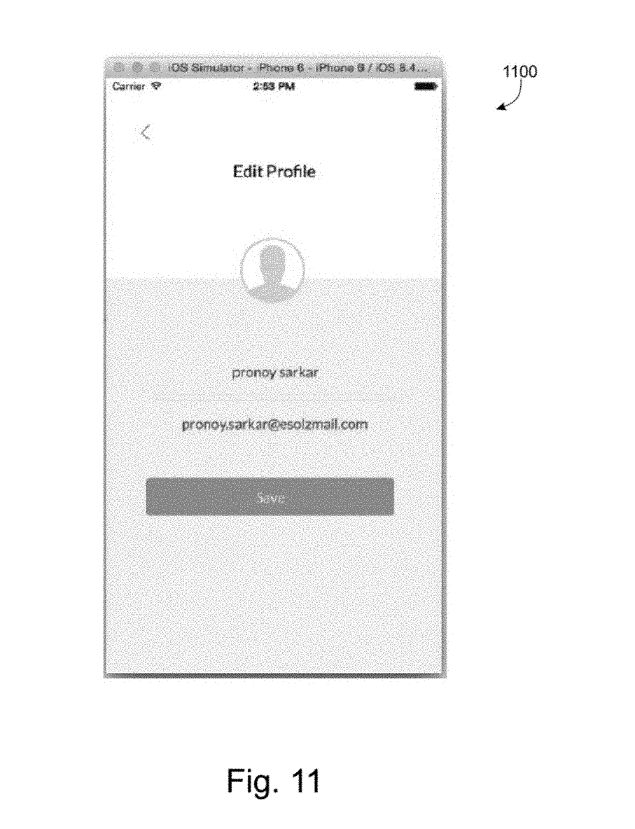

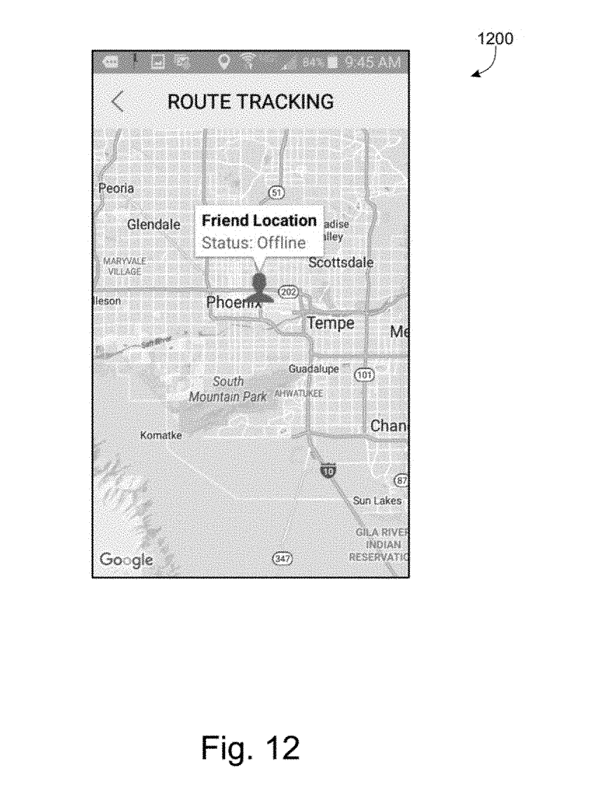

FIG. 9 is a screenshot depicting the add friend screen 1300, in accordance with at least one embodiment. FIG. 10 is a screenshot depicting the settings screen 1000, in accordance with at least one embodiment. FIG. 11 is a screenshot depicting the edit profile screen 1100, in accordance with at least one embodiment. FIG. 12 is a screenshot depicting the route-tracking screen 1200, in accordance with at least one embodiment. Therefore, friends and contacts listed by the user to provide the movement details and notified in case of any emergencies.

The present system and methods may be operated through a software application or a website with webinars, client testimonials, etc. and with monitoring sub-processes at the backend of site to log user activity. The monitoring sub-processes will keep track of appointment locations, open house registrations, log open house sign in registry pictures as described in the Registry process, client information, alarm notifications, renewal actions etc. Notably, the website feature will include a user access and administrator panel to aid in management tasks.

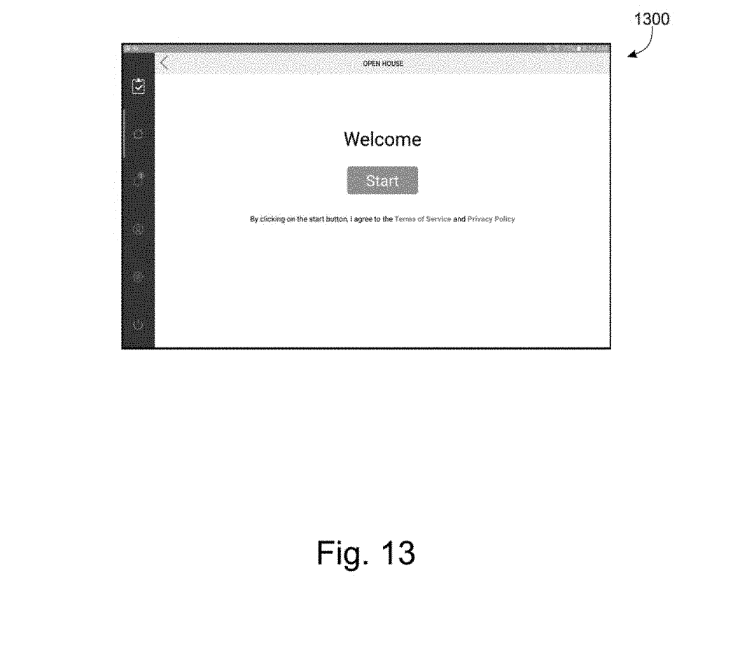

FIG. 13 is a screenshot depicting the welcome screen 1300, in accordance with at least one embodiment. The user may start the usage of the present system by accepting the terms and condition of the present system. Notably, one of the main purposes of this process is accountability. The client registers the contact information, including name/email address/phone number etc., for the user. The process will automatically send a follow-up thank you note etc., and records the information. The present system 100 also strives to capture the user's photo. This picture-taking sub-process capture an image of the person signing in, and store this on the host server 104. This way, in the event the user inputs false information, friends of the user, the user's employer, or law enforcement will at least have the registering party's facial photo and possibly a viable phone number to help track down the person. In this manner, picture and other information will be digitally stored in the website if the need arises for an investigation, or other police involvement.

Various embodiments of the disclosure provide a non-transitory computer readable medium and/or storage medium, and/or a non-transitory machine readable medium and/or storage medium having stored thereon, a machine code and/or a computer program having at least one code section executable by a machine and/or a computer to schedule an appointment between a user and a client through a host server 104 and further transmits the appointment information via a communication network 108 to a network ready device 106 to monitor the appointment in a dynamic virtual environment.

The one or more processors 110 are configured to register by receiving name, email, password, phone number, and image pertaining to the user and the client. The one or more processors 110 are further configured to store the received information. Then the one or more processors 110 configured to verify the stored information by sending a confirmation code to a computing device. Thereafter the one or more processors 110 configured to schedule the appointment of the client with the user. The one or more processors 110 further configured to send the scheduled appointment by the user to the client to get confirmation from the client. In an embodiment, the scheduled information includes a date, a time and a location of a place to meet.

The one or more processors 110 further configured to display a calendar of the scheduled appointments in the computing unit corresponding to the client and the user. The one or more processors 110 then configured to track the movement of the client in by the user to reach at the scheduled location. The one or more processors 110 further configured to add friend to track the user in real time over a digital map. The one or more processors 110 further configured to initiate an alarm in case of an emergency by the user.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited.

A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

Therefore, the present system and method cross verify the scheduled appointment of the user. Further, the present systems and methods allows to list the appointment dates and timing in the calendar of the user. The present systems and methods provide real-time tracking in order to ensure the safety and security of the user and the user.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for scheduling an appointment between a real estate agent and a user through a host server and further transmitting the appointment information via a communication network to a network ready device for monitoring the appointment in a dynamic virtual environment, the method comprising:
registering, by one or more processors, by receiving name, email, password, phone number, and image pertaining to the user;
storing, by the one or more processors, the received information;
verifying, by the one or more processors, the stored information by sending a confirmation code to a computing device;
scheduling, by the one or more processors, the appointment of the client with the user;
sending, by the one or more processors, the scheduled appointment by the user to the client to get confirmation from the client, wherein the scheduled information includes a date, a time and a location of a place to meet;
displaying, by the one or more processors, a calendar of the scheduled appointments in the computing unit corresponding to the user and the client; and
by being able to track, by the one or more processors, the movement of the client to the scheduled location.

2. The method according to claim 1 further includes adding friend, by the one or more processors, to track the user in real time over a digital map.

3. The method according to claim 1 further includes initiating a panic alert, by the one or more processors, in case of an emergency by the user.

4. An application server to schedule an appointment between a user and a client through a host server and further transmits the appointment information via a communication network to a network ready device to monitor the appointment in a dynamic virtual environment, the application server comprising:
one or more processors configured to:
register by receiving name, email, password, phone number of the client and the user,
store the received information;
verify the stored information by sending a confirmation code to a computing device;
schedule the appointment of the client with the user;
send the scheduled appointment by user to the client to get confirmation from the user, wherein the scheduled information includes a date, a time and a location of a place to meet;
display a calendar of the scheduled appointments in the computing unit corresponding to the user and the client; and
track the movement of the client.

5. The application server of claim 4, wherein the one or more processors further configured to add friend to track the user in real time over a digital map.

6. The application server of claim 4, wherein the one or more processors further configured to initiate an panic alert in case of an emergency by the user.

7. A non-transitory computer-readable storage medium having stored thereon, a set of computer-executable instructions for causing a computer comprising one or more processors to perform steps comprising:
registering, by one or more processors, by receiving name, email, password, phone number, pertaining to the real user and the client;
storing, by the one or more processors, the received information;
verifying, by the one or more processors, the stored information by sending a confirmation code to a computing device;
scheduling, by the one or more processors, the appointment of the client with the user;
sending, by the one or more processors, the scheduled appointment by the user to the client to get confirmation from the client, wherein the scheduled information includes a date, a time and a location of a place to meet;
displaying, by the one or more processors, a calendar of the scheduled appointments in the computing unit corresponding to the user and the client; and
tracking, by the one or more processors, the movement of the client.

8. The non-transitory computer readable medium according to claim 7 further includes adding friend, by the one or more processors, to track the user in real time over a digital map.

9. The non-transitory computer readable medium according to claim 7 further includes initiating a panic alert, by the one or more processors, in case of an emergency by the user.
